(19) United States
(12) Patent Application Publication
(10) Pub. No.: US 2013/0076135 A1
(43) Pub. Date: Mar. 28, 2013

(54) High-Power Boost Converter

(71) Applicants: Huibin Zhu, Westford, MA (US); Allen Ritter, Salem, VA (US)

(72) Inventors: Huibin Zhu, Westford, MA (US); Allen Ritter, Salem, VA (US)

(73) Assignee: GENERAL ELECTRIC COMPANY, Schenectady, NY (US)

(21) Appl. No.: 13/247,444

(22) Filed: Sep. 28, 2011

(51) Int. Cl. H02J 1/10

(52) U.S. Cl. 307/43

(57) ABSTRACT

A high-power boost converter including two or more inductors coupled to an input DC power source and to switches that can be modulated to control the output power of the high-power boost converter. The two or more inductors are further coupled to each other electrically, magnetically, or both electrically and magnetically.

### FIELD OF THE INVENTION

This invention generally relates to power converters, and in particular to boost converters for direct current (DC) voltage conversion.

### BACKGROUND OF THE INVENTION

Power converters are used to convert power from direct current (DC) power sources to alternating current (AC) power output for use on local loads or for delivery to a power grid. Such power converters are instrumental in applications such as for providing AC power from DC distributed power sources like photovoltaic (PV) cells. With an increased societal focus on anthropogenic environmental degradation, particularly in relation to green house gas (GHG) and certain other emissions, there has been an increased trend towards distributed renewable power generation. For example, in recent years, there has been a steep increase in the number of homes and businesses that have installed roof top solar cell arrays that generate power to power a home or business and also provide excess power to the power grid. Such distributed power generation sources may require power converters that are efficient, inexpensive, reliable, and have a minimal form factor. Conventional power converters typically comprise DC filters, boost converters, AC filters, inverters, and coupling to the power grid.

A conventional boost converter, also referred to as a boost chopper, receives DC power from one or more power sources and provides a single DC power output at an output voltage that is greater than the voltage of each of the DC power sources. As illustrated in FIG. 1, the DC power source can be a photovoltaic PV cell providing DC power directly to the boost converter 10. The boost converter 10 may optionally comprise a circuit breaker CB₁ and a DC filter. The DC filter comprises a capacitor C₁ and a resister R₁ in parallel. The input voltage vᵢ is provided to one or more inductors L₁ and L₂ in parallel. Current sensors, such as shunt resistors R₂ and R₃ may measure the current through the inductors L₁ and L₂, as i₁ and i₂, respectively. The boost converter further comprises switches S₁ and S₂ electrically connected to the inductors L₁ and L₂, respectively, that can be modulated to control an output voltage vₒ of the boost converter. The current measurements i₁ and i₂ may be used to control PWM signals provided to each of the switches S₁ and S₂. In operation, by controlling the period and duty cycle of PWM signals applied to the switches S₁ and S₂, the DC gain of the boost converter can be controlled.

In relatively high power applications, such as power converters for distributed generation points, boost converters must be able to operate at high currents and high-power. The inductors in particular for such applications can be relatively large, resulting in high material costs for the manufacture of the boost converters and reduced form factor in space constrained point-of-use (POU) distributed power generation sites. Additionally, such large inductors can result in high operating thermal loss and reduced efficiency.

### BRIEF SUMMARY OF THE INVENTION

In one embodiment, a boost converter can include a first inductor electrically coupled to the output of at least one power source and a second inductor electrically coupled to the output of the at least one power source and electrically coupled to the first inductor. The boost converter can further include a first electrical switch electrically coupled to both the first inductor and an output of the boost converter. The boost converter can further include a second electrical switch electrically coupled to both the second inductor and the output of the boost converter. During operation, both the first and second electrical switches can be repeatedly modulated to control an output voltage at the output of the boost converter.

In another embodiment, a method can be provided. The method can include providing at least one direct current (DC) power source and at least two inductors such that at least one inductor is electrically connected to the output of each of the at least one DC power sources. The method can further include providing at least two switches, where each switch is electrically connected to each of the at least two inductors and is repeatedly modulated, thereby providing an output voltage, wherein two or more of the at least two inductors are coupled to each other and the output voltage is greater than the sum of the output voltage of each of the at least one DC power sources.

In yet another embodiment, a photovoltaic (PV) power system can provide electrical power at an output voltage. The power system can include a first inductor electrically connected to the output of at least one PV source and a second inductor also electrically connected to the output of the at least one PV source, and electrically coupled to the first inductor. The PV power system can further include a first electrical switch electrically connected to both the first inductor and an output of the PV power system and a second electrical switch electrically connected to both the second inductor and the output of the PV power system. Both the first and second electrical switches can be repeatedly modulated to control the output voltage of the PV power system.

Other embodiments, features, and aspects of the invention are described in detail herein and are considered a part of the claimed inventions. Other embodiments, features, and aspects can be understood with reference to the following detailed description, accompanying drawings, and claims.

### BRIEF DESCRIPTION OF THE FIGURES

Reference will now be made to the accompanying tables and drawings, which are not necessarily drawn to scale, and wherein:

FIG. 1 is a circuit schematic of a conventional boost converter according to the prior art.

FIG. 2 is circuit schematic of an example boost converter according to an embodiment of the invention.

FIG. 3A are example pulse width modulation (PWM) control signals provided to the boost converter of FIG. 2 to operate the boost converter in accordance with an embodiment of the invention.

FIG. 3B are example PWM control signals where individual signal pulses do not overlap and can be provided to the boost converter of FIG. 2 to operate the boost converter in accordance with an embodiment of the invention.

FIG. 4 is a simplified equivalent circuit of the example boost converter of FIG. 2 during operation.

FIG. 5 is an example circuit schematic of a boost converter according to another embodiment of the invention.

FIG. 6 is a flow diagram of an example method to convert DC voltage according to an embodiment of the invention.

### DETAILED DESCRIPTION OF AN EMBODIMENT OF THE INVENTION

Embodiments of the invention are described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention may provide apparatus, systems, and methods for improved DC-to-DC voltage conversion. Such improvements may entail, for example, reduced cost and footprint of power conversion systems, reduced operating thermal losses and greater efficiency of boost converters with reduced ripple voltage of the converted DC output power. Such improvements may be implemented by incorporating more compact inductances, or inductors with greater inductance per unit volume, in the boost converter.

Example embodiments of the invention will now be described with reference to the accompanying figures.

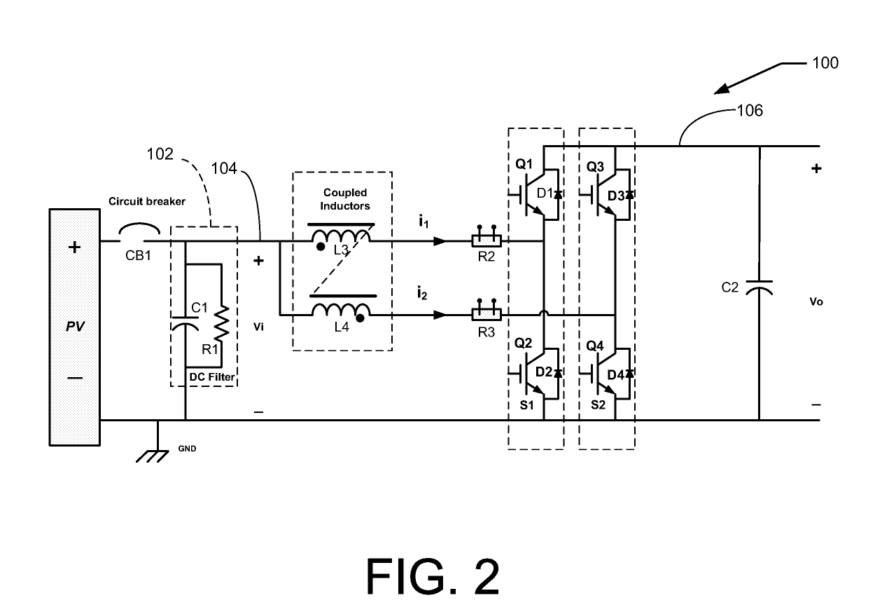

Referring now to FIG. 2, an example boost converter 100 according to an embodiment of the present invention is described. The boost converter 100 can receive DC power from a DC power source such as a photovoltaic cell PV. The boost converter 100 can optionally include a circuit breaker CB₁ for protecting the boost converter 100 against current or voltage spikes and a DC filter 102 for filtering out noise and other transients in the DC power such as, for example, electromagnetic interference (EMI). The DC filter includes a capacitor C₁ and resister R₁ in parallel with each other and shunted across an input port 104 and ground GND of the boost converter 100. The boost converter 100 can further include at least two inductors L₃ and L₄. The two inductors L₃ an L₄ can be electrically connected to each other at the input port 104 of the boost converter 100 where the voltage vᵢ referenced to ground GND is essentially the output voltage of the photovoltaic cell PV. Inductors L₃ and L₄ can also be coupled to each other either electrically, magnetically, or both electrically and magnetically.

The boost converter 100 can further include two switches S₁ and S₂ in parallel with each other and both connected to a output port 106 of the boost converter 100 with output voltage vₒ referenced to ground GND. Each of the switches S₁ and S₂ can include two transistors such as insulate gate bipolar transistors (IGBTs) Q₁, Q₂, Q₃, and Q₄ and two diodes D₁, D₂, D₃, and D₄ electrically connected across the emitter and collector of each of the IGBTs Q₁, Q₂, Q₃, and Q₄, respectively. The switches S₁ and S₂ in combination with their corresponding inductors L₃ and L₄, respectively, are often referred to as bridges of the boost converter 100.

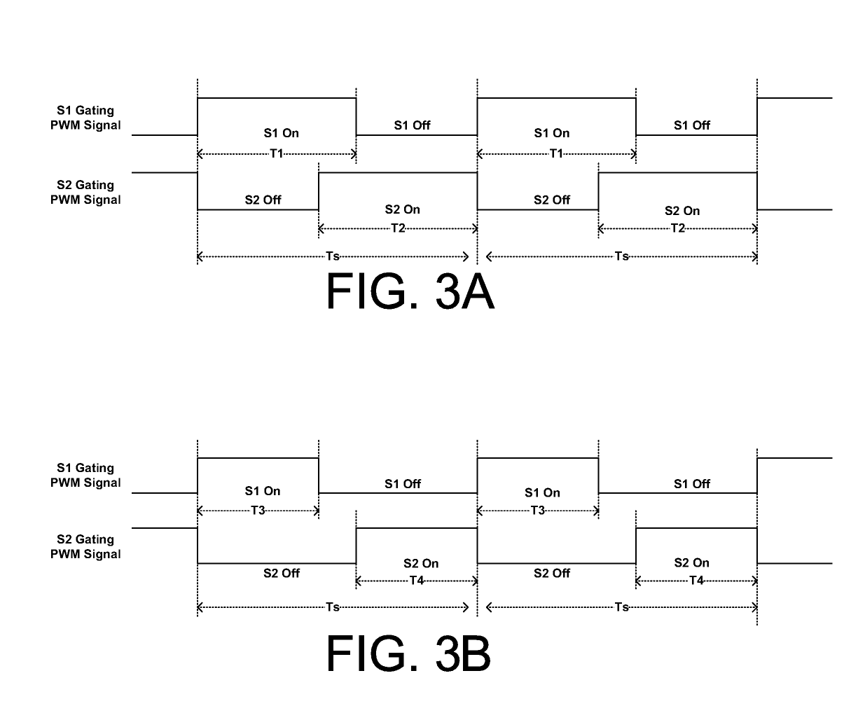

Continuing on with FIG. 2, the boost converter can additionally include current sensors illustrated in the form of shunt resisters R₂ and R₃ for measuring the current i₁ and i₂ through the inductors L₃ and L₄, respectively. The current measurements i₁ and i₂ may be used to generate and control signals to modulate the switches S₁ and S₂. More discussion with respect to the control signals to modulate the switches S₁ and S₂ is provided in conjunction with the descriptions of FIGS. 3A and 3B. The boost converter 100 can also include an output capacitor, commonly referred to as a DC bus capacitor C₂, connected across the output port 106 and ground GND.

In operation, the coupled inductors L₃ and L₄ conduct current from the DC power source PV to the switches S₁ and S₂ in a manner in which the switches conduct the current through each of the inductors L₃ and L₄ when the corresponding switch is turned on. Consider a single bridge containing the L₃ inductor to better illustrate this. When switch S₁ is turned on, current flows from the DC power source PV through the inductor L₃ and through IGBT Q₂ to ground GND. During the time while the switch S₁ is turned on, energy from the DC power source PV is stored in the inductor L₃ when the voltage across the inductor is vi. When the switch S₁ is subsequently opened, the voltage across the inductor L₃ is approximately (vₒ−vᵢ) and current flows through diode D₁ to the output port 106, charges up DC bus capacitor C₂, and flows to any load that may be connected to the output port 106.

The energy stored in the inductor L₃ when the switch S₁ is turned on is:

$$E = \frac{1}{2} {L}_{3} {I}_{L 3}^{2} \qquad ( 1 )$$

From equation (1) it is apparent that a greater inductance provides for the storage and transfer of a greater amount of energy. Therefore, for high power converter systems large inductances are needed for the transfer of the DC source PV power efficiently.

Continuing on with the operation of the boost converter 100, the voltage across an inductor is:

$${v}_{i} = L \frac{d i}{d t} \qquad ( 2 )$$

where L is the inductance of the inductor,

i is the current through the inductor, and

di/dt is the first derivative with respect to time of the current.

Applying equation (2) to the boost converter 100 when the switch S₁ is on, the change in current through the inductor can be determined as:

$$Δ {I}_{L 3 \_ o n} = \frac{1}{{L}_{3}} {\int }_{0}^{DT} {v}_{i} d t = \frac{{v}_{i} DT}{{L}_{3}} \qquad ( 3 )$$

where T is a period of a periodic modulation signal applied to the switch S₁, and

D is the duty cycle of the periodic modulation signal.

Now applying equation (2) to the boost converter 100 when the switch is off, the change in current through the inductor can be determined as:

$$Δ {I}_{L 3 \_ off} = \frac{1}{{L}_{3}} {\int }_{DT}^{T} ( {v}_{i} - {v}_{o} ) d t = \frac{( {v}_{i} - {v}_{o} ) ( 1 - D ) T}{{L}_{3}} \qquad ( 4 )$$

Since in steady state, the change in current during the on period and off period of the switch S₁ must sum to zero, equations (3) and (4) can be used to determine the DC gain from a single bridge of the boost converter as:

$$\frac{{v}_{o}}{{v}_{i}} = \frac{1}{1 - D} \qquad ( 5 )$$

When multiple bridges and inductors L₃ and L₄ are present in the boost converter 100, the DC voltage gain expression is different from equation (5), but is still dependent on the duty cycle of the signal used to modulate the switches S1 and S2.

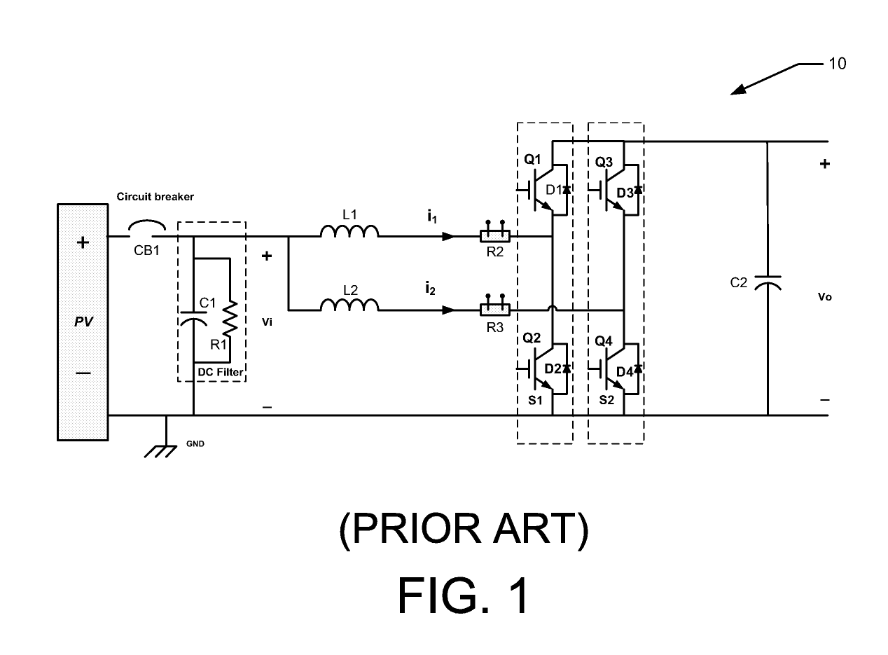

The inductors L₃ and L₄ of boost converter 100 can be coupled to each other in a manner that increases the inductance per unit volume of each of the inductors L₃ and L₄. In other words, by mutually coupling the inductors L₃ and L₄, the inductance of each of the coupled inductors L₃ and L₄ is greater than similarly sized inductors that are not coupled. Stated another way, the effective inductance of L₃ and L₄ are greater when they are coupled compared to if they were not coupled. The inductors L₃ and L₄ have both a self inductance component, as well as, a mutual inductance component. Therefore, the inductance of inductors L₃ and L₄ may be greater than the inductance of inductors L₁ and L₂ of boost converter 10 as depicted in FIG. 1, for inductors L₁, L₂, L₃, and L₄ with the same number of windings and same type and size of magnetic core. Additionally the volume occupied by the coupled inductors L₃ and L₄ of boost converter 100 may be less than the volume occupied by the non-coupled inductors L₁ and L₂ of boost converter 10.

As previously stated, having a greater inductance can reduce material usage and cost, as well as, reduce operating thermal loss, greater efficiency, and reduced ripple current in the output power. Additionally, because the current through each coupled inductor L₃ and L₄ is coupled to the current through the other coupled inductor L₃ and L₄, a reduced number of current sensors R₂ and R₃ may be needed for feedback control for generating and controlling the modulation signals for the switches S₁ and S₂.

In one aspect, the coupled inductors L₃ and L₄ may share a common magnetic core. Further the inductors L₃ and L₄ may have the same number of coil windings (not shown). As a result, the coupled inductors L₃ and L₄ may operate and present similar properties as a 1:1 transformer. By sharing a common core, the magnetic flux generated by the coil of one of the inductors L₃ and L₄ also passes through the coil of the other of the inductors L₃ and L₄. Any change in the magnetic field that the coils of both the inductors L₃ and L₄ experience may induce a current in both of the coils. Therefore, the coupled inductors L₃ and L₄ are electromagnetically coupled. By sharing a common core, the coupled inductors L₃ and L₄ may reduce materials usage and therefore reduce material costs for the construction of the boost converter 100.

In another embodiment, the coupled inductors L₃ and L₄ may not share a common magnetic core, but may be in proximity to each other so that the magnetic fields and magnetic flux emanating from each coupled inductor L₃ and L₄ are at least partially overlapping.

As another embodiment, the inductors may not have the same number of windings. Instead, in certain configurations of the boost converter 100, the inductors may have a dissimilar number of windings.

Although the boost converter is shown to have only two inductors L₃ and L₄, there may be any number of bridges, where bridges are defined as an inductor connected to a DC power source with a switch attached thereto. For example, a boost converter may include four bridges, where two of the inductors are mutually coupled to each other and the other two inductors are not coupled to each other. As a further example, a boost converter may include four bridges where two of the inductors are mutually coupled to each other and the other two inductors are mutually coupled to each other, but all four inductors are not mutually coupled to each other. As yet a further example, a boost converter may include three bridges where all three inductors are mutually coupled to each other.

In one example, in a conventional three bridge boost converter, the inductance of each of the three inductors may be in the range of about 150 to 300 micro-Henries (pH). For a three bridge boost converter, similar with respect to chopping frequency, output-to-input voltage ratio, and power rating, where the inductors are mutually coupled to each other, each of the inductors may have self inductance in the range of about 20 to 45 μH and mutual inductance in the range of about 130 to 250 pH. In the case where the inductors are mutually coupled, the total physical volume of the inductors may be about 15 to 30% less than in the case where the inductors are not mutually coupled.

In another embodiment, each bridge may include more than one discreet inductor in series. In other words, there may be two or more inductors in series connected to a switch. In such a configuration one or more of the two or more inductors may be coupled to an inductor from another bridge of the boost converter. For example, a boost converter may include two bridges with each bridge having two inductors in series, with an inductor from the first bridge mutually coupled to an inductor from the second bridge, but the other two inductors are not mutually coupled.

Although, the DC power source is illustrated as a photovoltaic (PV) cell, it can, in other embodiments, be any DC power source including, but not limited to, a photovoltaic array, a fuel cell, and electrolytic cell, or combinations thereof. As a further embodiment, the power source can be non-DC power sources such as from wind harvesting, water harvesting, or solar-thermal (solar concentrator) sources. Additional power sources can include a rectified turbine-generator output where the turbine is driven using any variety of known methods including, but not limited to, burning of fossil fuels and other hydrocarbons, nuclear, hydroelectric, or combinations thereof.

The optional circuit breaker CB₁ may be any known variety of circuit breakers. The purpose of the circuit breaker is to prevent or otherwise minimize any voltage surges from damaging or otherwise preventing the operation of the DC boost converter 100.

The resistor R₁ and capacitor C₁ of the optional DC filter 102 may have appropriate values to filter out spurious transients from the power source PV that may negatively impact the operation of the boost converter 100. For example, spurious transients and very high frequency components may be output from the power source PV when a cloud or some other object casts a shadow on the PV cell and then again when the cloud or other object no longer casts a shadow on the cell. The purpose of the DC filter 102 is, among other things, to filter out such transients and high frequency components from the DC power source PV. The DC filter 102 may be implemented in other configurations than the RC configuration shown, including LC or RLC configurations as is well understood in the art.

The signal from the current sensors in the form of shunt resisters may be provided to a controller (not shown) to generate control signals such as pulse width modulation (PWM) signals for modulating the switches S₁ and S₂. The current sensors may be any known apparatus for measuring current such as an ammeter.

Although the switches S₁ and S₂ are shown to comprise two IGBTs and two diodes each, there can be many other implementations of the switches S₁ and S₂. To illustrate further, consider switch S₁ connected to inductor L₃. In one implementation of the switch S₁, the top IGBT Q₁ and diode D₁ combination may be replaced by a single diode. A similar implementation may be used for switch S₂.

It should be noted, that the circuit topology of the boost converter 100 may be modified in various ways in accordance with certain embodiments of the invention. For example, in certain embodiments, one or more circuit components may be eliminated or substituted with equivalent or nearly equivalent circuit elements. Additionally, in other embodiments, other circuit elements may be added to or present in the boost converter 100.

Referring now to FIG. 3A and FIG. 3B, the modulation of the switches S₁ and S₂ are further discussed. FIG. 3A shows example interleaved PWM signals for switch S₁ on top and for switch S₂ on the bottom. Both the S₁ and S₂ PWM signals have a period of Tₛ. The S₁ signal has a duty cycle of T₁/Tₛ and the S₂ signal has a duty cycle of T₂/Tₛ. The time period in this example Tₛ is less than the sum of the on time within a period of the two signals (T₁+T₂). As a result there is a period of time when both switches S₁ and S₂ are turned on. The relative phase between the two PWM signals is 180° and interleaving the two PWM signals with a phase of 180° may reduce ripple current at the output port 106 of the boost converter.

FIG. 3B again shows example interleaved PWM signals for switch S₁ on top and for switch S₂ on the bottom with both signals having a period of Tₛ. The S₁ PWM signal has a duty cycle of T₃/Tₛ and the S₂ PWM signal has a duty cycle of T₄/Tₛ. The relative phase between the two PWM signals is again 180° and interleaving the two PWM signals with a phase of 180° may reduce ripple current at the output port 106 of the boost converter. The time period in this example Tₛ is greater than the sum of the on time within a period of the two signals (T₃+T₄). As a result there is a period of time when both switches S₁ and S₂ are turned off.

Either of the PWM signal sets of FIGS. 3A and 3B may be applied to the boost converter 100 of FIG. 2 to operate the boost converter according to an embodiment of the invention disclosed herein. The PWM signals of FIGS. 3A and 3B are merely exemplary in nature. Any variety of other PWM and non-PWM signals may be used to repeatedly modulate the switches S₁ and S₂.

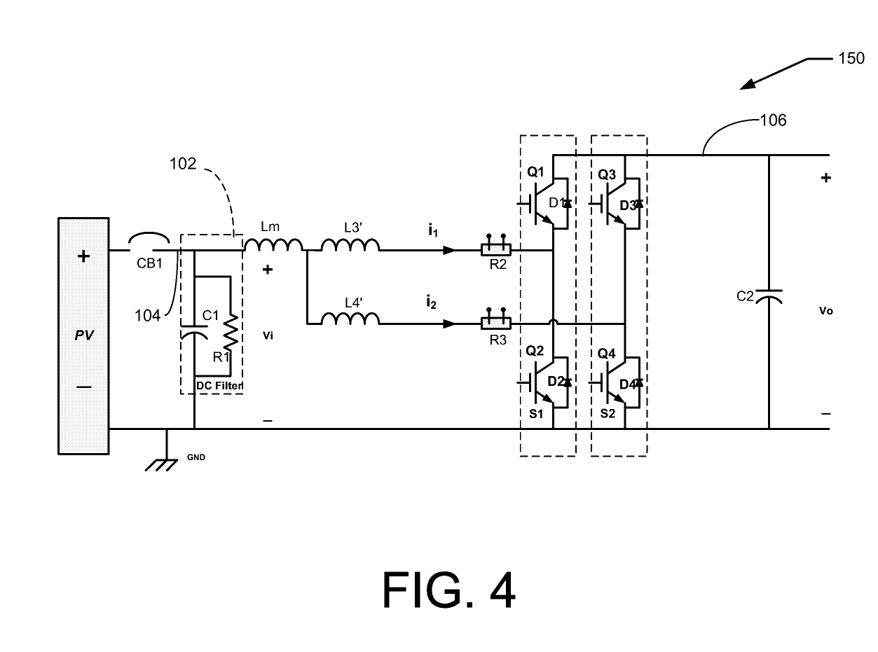

FIG. 4 shows an example simplified equivalent circuit 150 of the boost converter 100, where like elements are labeled with like reference labels and reference numerals to that of boost converter 100 as depicted in FIG. 2. In the interest of brevity, like elements will not be described for the equivalent circuit 150. The coupled inductors L₃ and L₄ of the boost converter 100 can be represented by non-coupled equivalent inductors L₃′ and L₄′ and a mutual inductance element Lₘ, when the boost converter 100 is in operation and PWM signals such as those of FIGS. 3A and 3B are applied to switches S₁ and S₂. In one aspect the effective inductance of the equivalent inductors L₃′, L₄′, and Lₘ are greater than the self inductance of the coupled inductors L₃ and L₄. In other words, the combined inductance of L₃′ and L₄′ with Lₘ is greater than non-coupled inductors of similar volumetric size as coupled inductors L₃ and L₄.

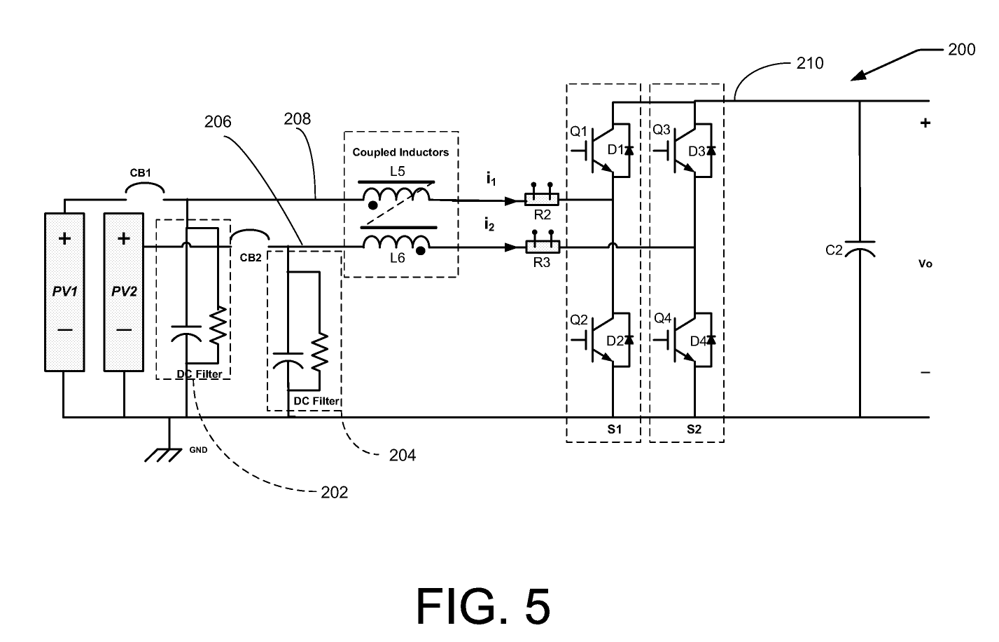

FIG. 5 shows an example circuit diagram of a boost converter 200 according to another embodiment of the invention where there are two DC power source depicted as PV₁ and PV₂ providing DC power to the boost converter 200 via two input ports 206 and 208 after passing through corresponding circuit breaker CB₁ and CB₂. Each of the input ports 206 and 208 may optionally have a DC filter to filter out high frequency signals and transients form each of the DC power sources PV₁ and PV₂. Each of the input ports 206 and 208 are further connected to a coupled inductor L₅ and L₆. As discussed above, the coupled inductors L₅ and L₆ are mutually coupled either electrically, magnetically, or both electrically and magnetically. The coupled inductors L₅ and L₆ can each have an effective inductance that is greater than the inductance of similarly sized and constructed inductors that are not mutually coupled. In this embodiment of the boost converter 200, the coupled inductors L₅ and L₆ may share a common magnetic core, resulting in mutual coupling and reduced size of the coupled inductors L₅ and L₆. The operation of the current sensors R₂ and R₃ and the switches S₁ and S₂ are largely the same as described in conjunction with the boost converter 100 of FIG. 2. To operate boost converter 200 either of the PWM signal sets of FIG. 3A or 3B may be applied to switches S₁ and S₂.

As in the previous embodiment of the boost converter 100 of FIG. 2, in this embodiment of the boost converter 200, the coupling of the inductors L₅ and L₆ can provide reduced material usage and cost, as well as, reduced operating thermal loss, greater efficiency, and reduced ripple current in the output power. Additionally, because the current through each coupled inductor L₅ and L₆ is coupled to the current through the other couple inductor L₅ and L₆, a reduced number of current sensors R₂ and R₃ may be needed for feedback control for generating and controlling the modulation signals for the switches S₁ and S₂. Furthermore, specific to this embodiment of the boost converter 200 with more than one DC power source PV₁ and PV₂, the inherent coupling of the currents through the coupled inductors L₅ and L₆ may allow for a reduced rating, and therefore smaller size of the circuit breakers CB₁ and CB₂.

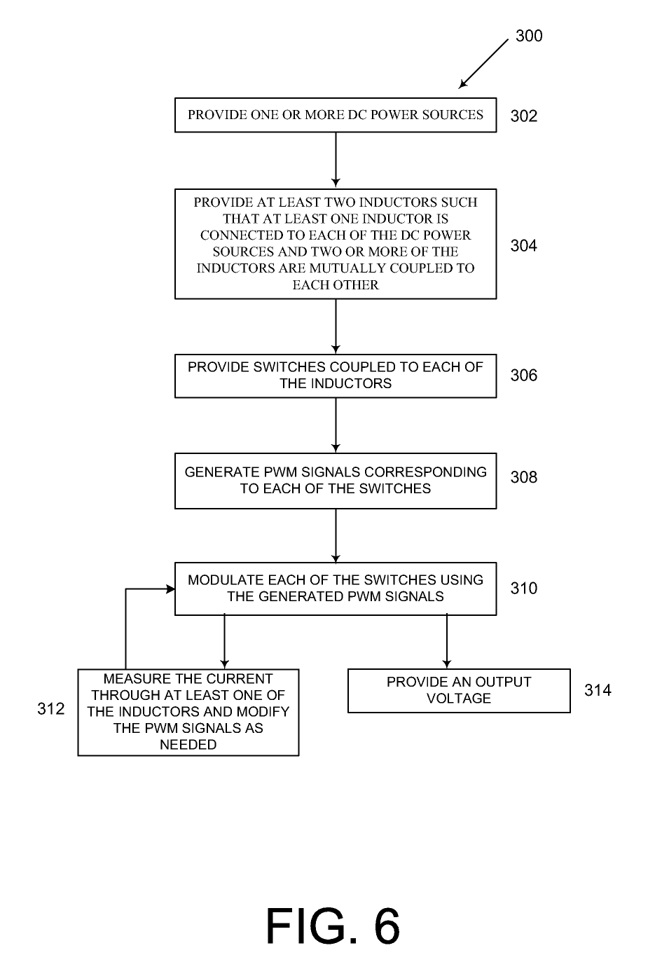

Referring now to FIG. 6, an example method 300 of providing a DC-to-DC conversion is depicted. The method 300 can be implemented using the circuits, apparatus, signals, and systems as disclosed in reference to FIGS. 2, 3A, 3B, and 5. At 302, one or more DC power sources are provided. As shown in FIGS. 2 and 5, the DC power sources may in one aspect be photovoltaic PV cells. At 304, at least 2 inductors are provided such that at least one of the inductors is connected to each of the DC power sources and 2 or more of the inductors are mutually coupled to each other. As discussed in reference to FIGS. 2 and 5, the coupling of the inductors may entail electrical coupling, magnetic coupling, or both electrical and magnetic coupling. At 306, switches are provided that are coupled to each of the inductors. At 308, PWM signals for modulating each of the switches are generated. Exemplary PWM control signals have been discussed in conjunction with FIGS. 3A and 3B. Each of the generated PWM signals are provided to the switches to modulate the switches at 310. Current may be measured through one or more of the inductors and the measurement may be used to modify the generated PWM signals at 312. As the switches are modulated, at 314, an output voltage and output power are provided at the output port.

It should be noted, that the method 300 may be modified in various ways in accordance with certain embodiments of the invention. For example, one or more operations of method 300 may be eliminated or executed out of order in other embodiments of the invention. Additionally, other operations may be added to method 300 in accordance with other embodiments of the invention.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A photovoltaic (PV) power system providing electrical power at an output voltage and comprising:
a first inductor electrically connected to the output of at least one PV source;
a second inductor electrically connected to the output of the at least one PV source, and electrically coupled to the first inductor;
a first electrical switch electrically connected to both the first inductor and an output of the PV power system; and,
a second electrical switch electrically connected to both the second inductor and the output of the PV power system,
wherein both the first and second electrical switches are repeatedly modulated to control the output voltage.

2. The PV power system of claim 1, wherein the at least one PV source comprises a first and a second PV source and the first inductor is coupled to the first PV source and the second inductor is coupled to the second PV source.

3. The PV power system of claim 1, further comprising a direct current (DC) filter corresponding to each of the at least one PV sources.

4. The PV power system of claim 1, wherein the first and second inductors share a common magnetic core.

5. The PV power system of claim 1, further comprising a first current sensor to measure the current through the first inductor and a second current sensor to measure the current through the second inductor.

6. The PV power system of claim 5, wherein the measured current through the first and second inductors is used to control the modulation of the first and second switches.

7. The PV power system of claim 1, wherein the first and second electrical switches each comprise at least two insulated gate bipolar junction transistors (IGBTs) and at least two diodes.

8. A boost converter comprising:
a first inductor electrically coupled to the output of at least one power source;
a second inductor electrically coupled to the output of the at least one power source, and electrically coupled to the first inductor;
a first electrical switch electrically coupled to both the first inductor and an output of the boost converter; and,
a second electrical switch electrically coupled to both the second inductor and the output of the boost converter,
wherein both the first and second electrical switches are repeatedly modulated to control an output voltage at the output of the boost converter.

9. The boost converter of claim 8, wherein the at least one power source comprises a first and a second power source and the first inductor is coupled to the first power source and the second inductor is coupled to the second power source.

10. The boost converter of claim 8, wherein the at least one power source comprises one or more direct current (DC) power sources.

11. The boost converter of claim 8, further comprising a direct current (DC) filter connected to each of the at least one power sources.

12. The boost converter of claim 8, wherein the first and second inductors share a common magnetic core.

13. The boost converter of claim 8, wherein the at least one power source comprises a single DC power source and the first and second inductors are in parallel with each other.

14. The boost converter of claim 8, further comprising a first current sensor to measure the current through the first inductor and a second current sensor to measure the current through the second inductor.

15. The boost converter of claim 14, wherein the measured current through the first and second inductors is used to control the modulation of the first and second switches.

16. The boost converter of claim 8, wherein the first and second electrical switches each comprise at least two insulated gate bipolar junction transistors (IGBTs) and at least two diodes.

17. The boost converter of claim 8, further comprising a capacitor shunted across the output of the boost converter.

18. A method comprising:
providing at least one direct current (DC) power source;
providing at least two inductors such that at least one inductor is electrically connected to the output of each of the at least one DC power sources;
providing at least two switches, each switch electrically connected to each of the at least two inductors and is repeatedly modulated; and,
providing an output voltage,
wherein two or more of the at least two inductors are coupled to each other and the output voltage is greater than the output voltage of each of the at least one DC power sources.

19. The method of claim 18, wherein repeatedly modulating each of the at least two switches comprises generating a pulse width modulation (PWM) signal corresponding to each of the switches.

20. The method of claim 19, wherein each of the PWM signals are generated based in part upon a measured current through each of the at least two inductors.
